(19) United States
(12) Patent Application Publication
(10) Pub. No.: US 2018/0199326 A1
(43) Pub. Date: Jul. 12, 2018

(54) REAL TIME ADAPTATION OF A MOBILE REPEATER ANTENNA PATTERN

(71) Applicant: Nextivity, Inc., San Diego, CA (US)

(72) Inventor: Michiel Petrus Lotter, San Diego, CA (US)

(21) Appl. No.: 15/867,551

(22) Filed: Jan. 10, 2018

Related U.S. Application Data
(60) Provisional application No. 62/444,757, filed on Jan. 10, 2017.

(51) Int. Cl. H04W 72/04; H04B 7/155; H04W 16/28; H04W 64/00; H04W 52/02

(52) U.S. Cl. CPC H04W 72/046; H04B 7/15507; H04W 84/005; H04W 64/003; H04W 52/0206; H04W 16/28

(57) ABSTRACT

This document describes a system that is used to dynamically adapt the radiation pattern of the donor antenna of a mobile repeater system. In some implementations, a switched beam antenna is used, in which a location of a mobile repeater is determined relative to a base station, as well as directionality relative to the base station. A correct beam, i.e., a beam with the highest gain based on the location and directionality, is determined and switched on based on a determined gain of that beam.

### CROSS-REFERENCE TO RELATED APPLICATION

The current application claims priority to U.S. Provisional patent application Ser. No. 62/444,757, filed on Jan. 10, 2017, entitled “REAL TIME ADAPTATION OF A MOBILE REPEATER ANTENNA PATTERN”, which is incorporated by reference herein in its entirety.

### BACKGROUND

The present invention is related to mobile repeaters, and more particularly to a system and method for dynamically adapting a radiation pattern of a donor antenna of a mobile repeater system.

In a mobile repeater system, a donor antenna is one that receives a signal from a carrier's radio tower (i.e., the “donor”). It delivers this signal to in-building or in-vehicle cellular solutions, such as a user antenna and can be mounted externally or internally relative the building or vehicle. The gain of the donor antenna is a big determining factor in the performance of the system. The higher the gain of the donor antenna, the weaker the usable input signal into the mobile repeater becomes, and hence the further away from the base station the user can be and still reliably use his cellular handset. In order to increase the gain of the donor antenna above that of an omni-directional antenna, the radiation pattern typically must change from an omni-directional pattern to a directional pattern as directional antenna have higher gain that omni-directional antennas.

The issue with a mobile repeater is that the location of the base station relative to the moving repeater is unknown and changing all the time, making the implementation of a directional, mobile donor antenna for a repeater difficult. One obvious solution to this problem would be to have an active antenna array wherein the beam pattern of the donor antenna is constantly adapted to maximize the gain of the antenna array in the direction of the donor base station. However, active antenna arrays are costly to implement, and also require a significant amount of computational power in order to dynamically adjust to the changing relative location of the base station.

### SUMMARY

This document describes a system that is used to dynamically adapt the radiation pattern of the donor antenna of a mobile repeater system.

In some aspects, the system includes a simpler antenna type than an active antenna array, such as a switched beam antenna. Note that a switched beam antenna is only an example of an embodiment of an antenna with high gain.

In some aspects, a mobile repeater system includes a donor antenna. The donor antenna generates a beam pattern for communicating signals with a base station. The beam pattern has a number of beams directed out in a number of directions from the donor antenna, and one of the beams is an optimal beam for the wireless communication with the base station. The system further includes a geolocation device associated with the mobile repeater, and a directional sensor associated with the mobile repeater. The system further includes a control processor for determining a first optimal beam of the beams directed out from the donor antenna for communicating signals with the base station. The control processor is further configured to receive input from the geolocation device and the directional sensor to switch communications between the mobile repeater and the base station from the first optimal beam of the beams to another optimal beam, based on a location and/or directionality of the mobile repeater relative to the base station.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates an example of a beam pattern of an antenna; and

FIG. 2 illustrates a method for dynamically adapting a radiation pattern of a donor antenna of a mobile repeater system.

Like reference symbols in the various drawings indicate like elements.

### DETAILED DESCRIPTION

This document describes a system that is used to dynamically adapt the radiation pattern of the donor antenna of a mobile repeater system. In some implementations, a system and method uses a simpler antenna type than an active antenna array, such as a switched beam antenna, for instance. A switched beam antenna is only an example of an implementation of an antenna with high gain.

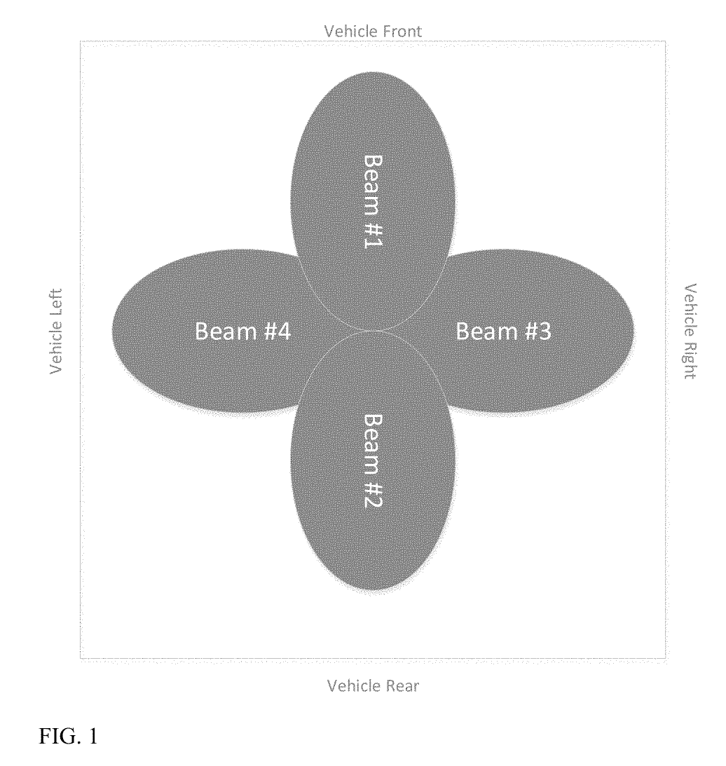

In some implementations, a switched beam antenna is used, in which a location of a mobile repeater is determined relative to a base station, as well as directionality relative to the base station. A correct beam, i.e., a beam with the highest gain based on the location and directionality, is determined and switched on based on a determined gain of that beam. An example of the beam pattern of such a donor antenna of a mobile repeater is shown in FIG. 1.

In FIG. 1, the repeater donor antenna has four beams: one pointing to the front, rear, right and left sides of the antenna, respectively. While the exemplary donor antenna beam pattern of the mobile repeater shown in FIG. 1 has four beams, any number of beams can be employed. At any point in time, only a single beam, i.e., the beam pointing to the closest base station, is active. Determining which antenna beam is the correct one can be done in various ways, but typically the beam can be chosen to maximize the wanted signal level at the input to the repeater. The process of determining the correct beam pattern can take a relatively long time initially as all beam patterns need to be scanned to find the optimum beam pattern. Once the correct pattern is found, the problem is maintaining the correct pattern as the mobile repeater moves relative to the carrier's radio tower.

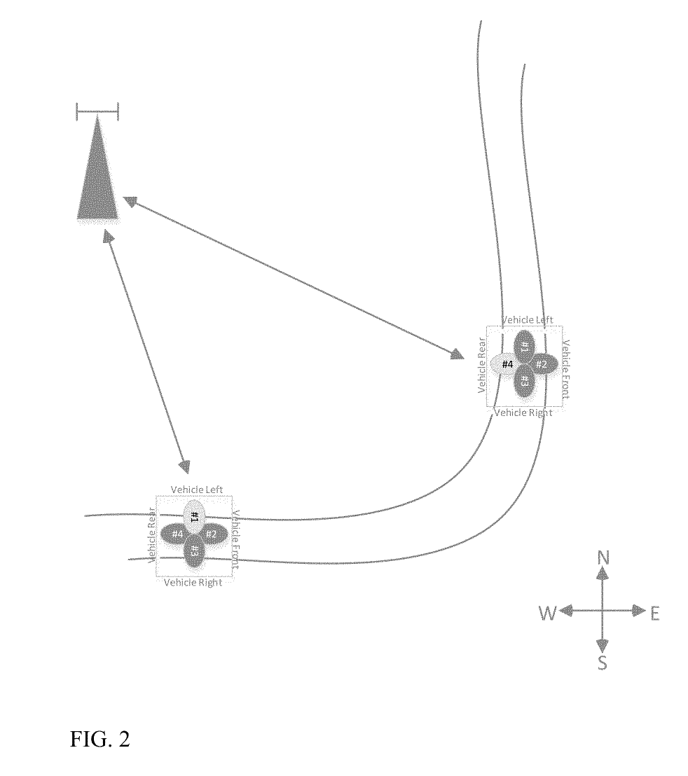

Consider the scenario shown in FIG. 2, and assume the vehicles start in the bottom left position. In this position, the repeater determines that antenna beam #1 has the optimum pattern, and the system automatically selects this pattern. As the vehicle travels East according to the directionality of FIG. 2, beam pattern #1 remains the optimum pattern.

However, as the vehicle turns North, the optimum pattern changes from antenna beam #1 to antenna beam #4, and the mobile repeater must adapt to this change as quickly as possible or risk a call being dropped for example. A key is a method to make this rapid decision on the correct beam pattern to choose.

Accordingly, in some implementations, a mobile repeater donor antenna includes a method of determining the direction in which the antenna is moving, such as receiving input from a magnetometer or gyroscope. In yet other implementations, a processing algorithm takes a known current optimum beam direction, the current configuration of the antenna, and adjusts it by incorporating a travel direction of the antenna to track the location of the optimum base station.

In some implementations, according to one example, an antenna system includes a magnetometer. When the repeater starts moving, a control system of the antenna system knows beam #1 is the optimum pattern and that the antenna is moving in an easterly direction. When the antenna starts to move in a northerly direction, the system calculates that it has to switch to beam #4 as it would now be pointing to the same base station to which beam #1 was originally pointing.

A mobile repeater system can include a geolocation device, and/or a directionality determining device, and a control processor for receiving both geolocation data and/or directionality data to determine an optimal beam for communicating with a base station. Accordingly, a system can include a switched beam antenna in which communications is switched from one beam to another based on a location and directionality of the mobile repeater system relative to a base station.

Although a few embodiments have been described in detail above, other modifications are possible. Other embodiments may be within the scope of the following claims.

1. A method of real time adaptation of a pattern of an antenna of a mobile repeater to communicate with a base station, the method comprising:
establishing, by a control processor, a current beam pattern for the antenna of the mobile repeater, the current beam pattern being established for optimal communications with the base station based on a current location of the mobile repeater relative to the base station;
receiving, by the control processor, input from a directional sensor associated with the mobile repeater;
determining, by the control processor according to the input, a direction in which the mobile repeater is moving; and
adjusting, by the control processor, the current beam pattern to a new beam pattern to incorporate the direction in which the mobile repeater is moving and a new location of the mobile repeater relative to the base station.

2. The method in accordance with claim 1, wherein the directional sensor is a magnetometer.

3. The method in accordance with claim 1, wherein the directional sensor is a gyroscope.

4. The method in accordance with claim 1, wherein receiving, by the data processor, input from the directional sensor associated with the mobile repeater further comprises receiving location data from a geolocation device associated with the mobile repeater.

5. A system for real time adaptation of wireless communication with a base station, the system comprising:
a mobile repeater having a donor antenna, the donor antenna generating a beam pattern having a plurality of beams directed out from the donor antenna for communicating signals with the base station;
a geolocation device and/or a directional sensor associated with the mobile repeater; and
a control processor for determining an optimal beam of the plurality of beams directed out from the donor antenna for communicating signals with the base station, the control processor further receiving input from the geolocation device and/or the directional sensor to switch communications between the mobile repeater and the base station from the optimal beam of the plurality of beams to another beam of the plurality of the beams, based on a location and/or directionality of the mobile repeater relative to the base station.

6. The system in accordance with claim 5, wherein the directional sensor is a magnetometer.

7. The system in accordance with claim 5, wherein the directional sensor is a gyroscope.

8. The system in accordance with claim 5, wherein the beam pattern is fixed.

9. A mobile repeater having real time adaptation of wireless communication with a base station, the mobile repeater comprising:
a donor antenna that generates a beam pattern for communicating signals with the base station, the beam pattern having a plurality of beams directed out in a plurality of directions from the donor antenna, one of the plurality of beams being an optimal beam for the wireless communication with the base station;
a geolocation device associated with the mobile repeater;
a directional sensor associated with the mobile repeater; and
a control processor for determining a first optimal beam of the plurality of beams directed out from the donor antenna for communicating signals with the base station, the control processor further receiving input from the geolocation device and the directional sensor to switch communications between the mobile repeater and the base station from the first optimal beam of the plurality of beams to another optimal beam of the plurality of the beams, based on a location and/or directionality of the mobile repeater relative to the base station.

10. The system in accordance with claim 9, wherein the directional sensor is a magnetometer.

11. The system in accordance with claim 9, wherein the directional sensor is a gyroscope.

12. The system in accordance with claim 9, wherein the beam pattern is fixed.
